(19) United States
(12) Patent Application Publication
(10) Pub. No.: US 2007/0022725 A1
(43) Pub. Date: Feb. 1, 2007

(54) Cutting device for taking care of lawns and the countryside comprising a device for receiving and comminuting cut items

(76) Inventor: Jakob Voets, Huckelhoven (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/519,646

(22) PCT Filed: Jun. 27, 2003
(86) PCT No.: PCT/DE03/02141

§ 371 Date: May 1, 2006

(30) Foreign Application Priority Data
Jun. 27, 2002 (DE) 102 28 880.1

(51) Int. Cl. A01D 87/10

(52) U.S. Cl. 56/13.3

(57) ABSTRACT

The invention relates to a device for receiving and comminuting cut items in a mowing unit (10) for taking care of lawns and the countryside. The cutting unit (10) comprises at least one cutting system which is made up of at least one cutting unit (20). The invention is characterised in that the device comprises a chopping machine (30) which receives, comminutes and transfers cut items (120) into an ejecting unit (80), said cut items being produced by at least one cutting unit (20). The rotational axis (50) of the chopping machine (30) is inclined in relation to the rotational axis (21) of the cutting unit (20).

The invention relates to a method and to a device for picking up and comminuting clippings in a mowing unit used for taking care of lawns and fields, whereby the mowing unit comprises at least one mowing assembly consisting of at least one mowing aggregate.

In the care of lawns and fields, self-propelled mowing units consisting of a tractor with a seat and several mowing assemblies are normally employed to mow large lawns and meadows. Typically, the mowing assemblies have rotating cutting means such as blades which cut the grass that is to be mowed. The cut grass is then either left behind on the ground and has to be picked up and hauled away in additional work steps, or else the mowing unit has a device for picking up the clippings. Normally, such mowing units have collecting containers for the picked-up grass.

Since mowing aggregates typically have covers directly above the cutting means, conventional mowing units cause the clippings to be squashed, thus forming a damp mass that is difficult to handle. For one thing, since the clippings are damp, they adhere to parts of the machine and moreover, their considerable volume makes it necessary to haul away the clippings after or between mowing operations.

German Preliminary Published Application No. 199 53 380 discloses a self-propelled mowing unit with several mowing assemblies. The mowing assemblies consist of several mowing aggregates arranged next to each other and having horizontally rotating blades. A so-called processing element is arranged along the individual mowing aggregates. The function and configuration of this processing element are not described.

German Preliminary Published Application No. 199 02 299 discloses a combination unit equipped with a chopper and an add-on lawn-mowing device. A vertically positioned chopping device and underneath it, a lawn-mowing device that can be switched on and off, are arranged in the upper area of the combination unit. Both devices are powered by a shared drive aggregate via a shared shaft.

German Utility Model No. 295 09 442 U1 discloses a lawn mower with a chopper in which a chopping device and a lawn-mowing device are likewise driven by the same engine. Both the blade of the chopper as well as the blade of the lawn-mowing device rotate around the axis of a drive shaft.

German Utility Model No. 1 998 721 U discloses a replaceable feed mechanism for field choppers consisting of rotating blades that cut the crop stalks and of chopping drums that comminute the cut crops. The crops are fed to the chopping drums via two counter-rotating cylinder drums that are positioned almost vertically and that have eccentric fingers. Instead of the cutter blades, other attachments such as pick-up mechanisms or beet root toppers can be used.

German Preliminary Published Application No. 195 28 435 A1 describes a method for mowing meadows, a method for composting the clippings, a mowing machine and a unit that processes the clippings. With the process and the appertaining devices, the clippings are fed via a conveying means to a compacting unit and then to a comminuting unit, for instance, in the form of a set of blades. Subsequently, the clippings are fed to a dehydrating unit that further compacts the clippings and squeezes most of the liquid out of them. The liquid can be used to improve the fertilization of landscaped areas.

U.S. Pat. No. 5,214,906 describes a riding-type lawn mower with a rear discharge slot that can effectively cut blades of grass that have been matted down by the front wheels of the lawn mower. For this purpose, two cutter blades move in opposite directions underneath a cutter housing.

German Published Examined Application No. 15 07 194 B2 discloses a field chopper for picking up and comminuting crops which is particularly convenient for being hitched to a towing vehicle such as a tractor. The crops in question are cut away from the soil by means of a mowing device and fed to the comminuting device located behind the mowing device in the forward direction of the vehicle. The field chopper serves especially to comminute tall crops such as, for instance, corn.

German Preliminary Published Application No. 28 50 294 A1 describes a machine for cutting and chopping plants and especially corn, which is hitched to a tractor. Here, the plants are picked up by a drum rotating around a perpendicular axle and they are conveyed to a blade that cuts the stalks. The cut corn stalks are further conveyed by a plate so as to lie flat and they are fed to a chopping device in such a way that they enter the latter with the bottom end first.

U.S. Pat. No. 3,677,316 describes a device for harvesting fodder crops that has an adjustable whetting stone to sharpen the cutter blades so that the blades do not have to be removed from the device in order to be sharpened. Here, it is particularly advantageous that, by changing the direction of rotation during the sharpening procedure, the blades are sharpened in such a way that there are no worn-down sections that would have a detrimental impact on the mowing operation.

The objective of the invention is to further develop a device of the generic type for taking care of lawns and fields in such a way that it produces dried clippings having a low volume.

According to the invention, this objective is achieved in that the device has a chopping device that picks up, comminutes and feeds clippings produced by at least one mowing aggregate to a discharge device, whereby the rotating axle of the chopping device is at an angle relative to the rotating axle of the mowing aggregate.

The objective is also achieved in that the plants being mowed are cut by cutting means of at least one mowing aggregate, after which these clippings are sucked in by a chopping device, where they are comminuted and then released in the vicinity of the mowing unit. After they have dried there, they are picked up once again by the chopping device and conveyed to a collecting means.

In an especially preferred embodiment of the method according to the invention, the clippings are picked up by the chopping device and discharged in the form of strips next to the mowing unit. If the weather is good, the clippings are left lying on the ground for some time in order to dry. Subsequently, they are picked up again by the mowing unit with the chopping device and comminuted once again, so that a volume reduction of up to 50% can be attained.

The device for taking care of lawns and fields is preferably a self-propelled mowing unit in the form of tractor with a seat. The unit has at least one mowing assembly that is preferably connected pivotally to the tractor by means of one or more axles. In a particularly preferred embodiment of the invention, the unit comprises two pivotable mowing assemblies located on the front of the tractor in the forward direction. The two mowing assemblies are preferably arranged in a V-formation. However, additional mowing assemblies can also be provided on the sides or at the back of the vehicle. Moreover, it is not absolutely necessary for the mowing assemblies to be pivotable, but rather, the chopping device according to the invention can also be installed in conventional, non-pivotable mowing assemblies.

The mowing assemblies employed each encompass at least one mowing aggregate consisting of rotating cutting means. The cutting means rotate around an axle that is essentially perpendicular to the ground surface to be mowed.

The chopping device for comminuting the clippings is located above the mowing assemblies, preferably extending over the two mowing assemblies that are closest to the tractor. However, the chopping device can also be installed next to the mowing assemblies, so that the clippings enter the device from the side.

The chopping device is configured in such a way that its chopping means rotate around an axle that is essentially perpendicular to the rotating axle of the cutting means of the mowing aggregate. This encompasses angles ranging from 60° to 90° between the axle of the cutting means and the axle of the chopping means. The chopping means are advantageously suitably shaped chopper blades or chopper flails of the type known from the state of the art.

The axle and the chopping means that rotate around it are located in a housing. This housing is open towards the side of the mowing aggregate so that it can suck in the clippings while, on the side opposite from the suction opening, it has another opening through which the comminuted clippings are discharged. If the chopping device is arranged above the mowing aggregate, the housing is consequently open towards the bottom so that it can pick up the clippings.

In a particularly preferred embodiment of the invention, a cover extends above each of the mowing aggregates of a mowing assembly. In order for the clippings not to be squashed between the cutting means and the cover, this cover is positioned at a certain minimum distance from the rotating cutting means of the aggregates. In the area of the chopping device, the appertaining cover has a cutout in order to allow the clippings to be picked up in the chopping device.

The grass to be mowed is cut off at an adjustable height by the rotating cutting means and the clippings are transported to the tractor of the mowing unit by means of the rotation of the cutting means underneath the cover: For this purpose, the cutting means rotate inwards in the direction of the longitudinal axis of the mowing unit. Once the clippings have reached the area underneath the chopping device, they are picked up by the rotation of the chopping means and sucked into the chopping device, where they are comminuted and discharged via the discharge opening.

The discharge opening is connected to a discharge device that is advantageously configured in such a fashion that the clippings can be discharged in different ways. Advantageously, the discharge device comprises at least one discharge chute that is preferably designed so that it can pivot and/or rotate around at least one axle. In this manner, the clippings can be discharged depending on the given requirements. They can be discharged for example, in the vicinity of the mowing unit, into a collecting container of the mowing unit or into a transport means.

Additional advantages, special features and advantageous refinements of the invention ensue from the subordinate claims and from the presentation below of preferred embodiments that make reference to the figures.

The figures show the following:

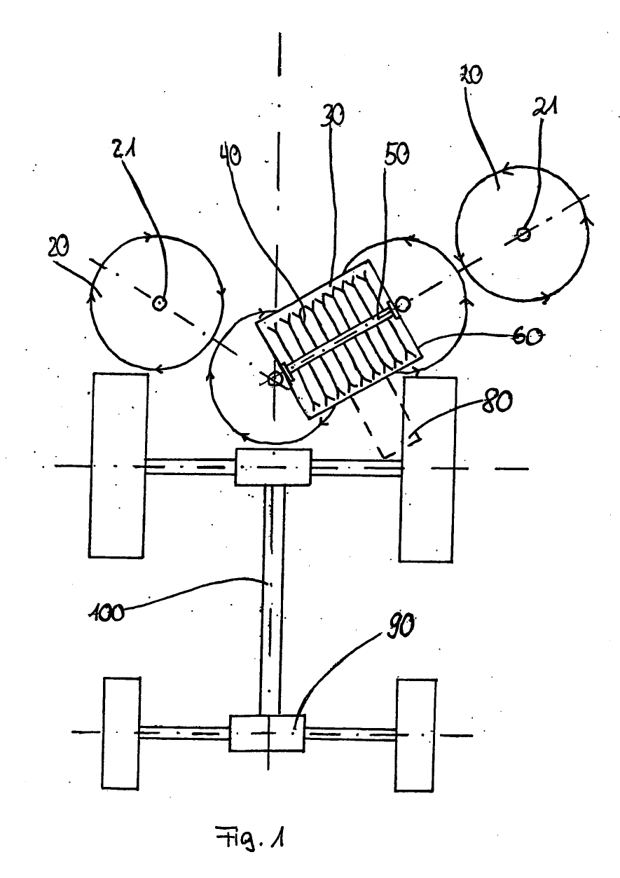

FIG. 1—a schematic top view of a particularly preferred embodiment of a self-propelled mowing unit with a chopping device according to the invention;

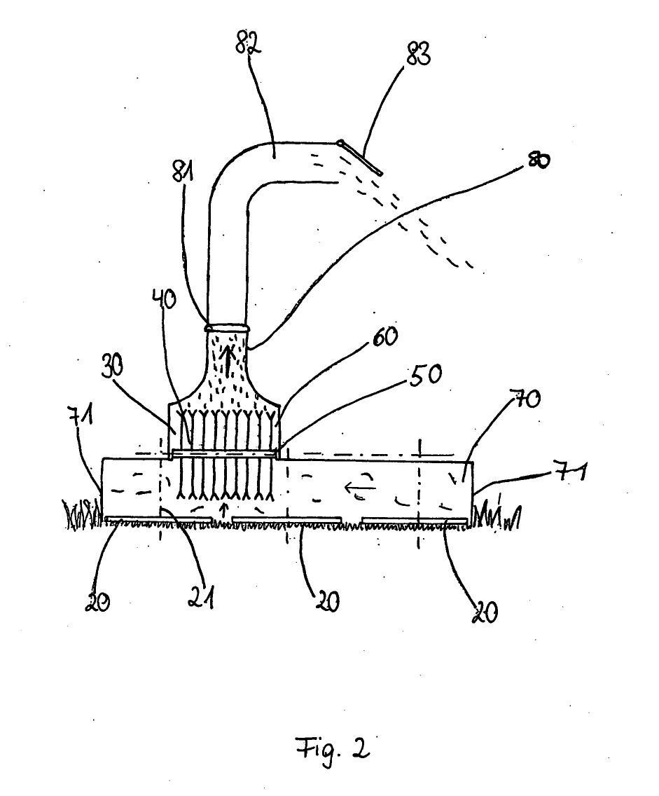

FIG. 2—a side view of the chopping device according to the invention;

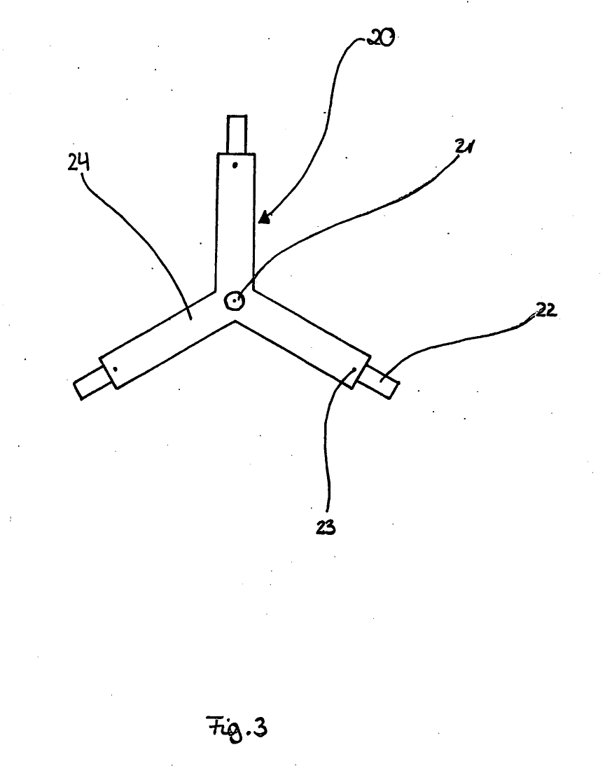

FIG. 3—a mowing aggregate with cutter blades;

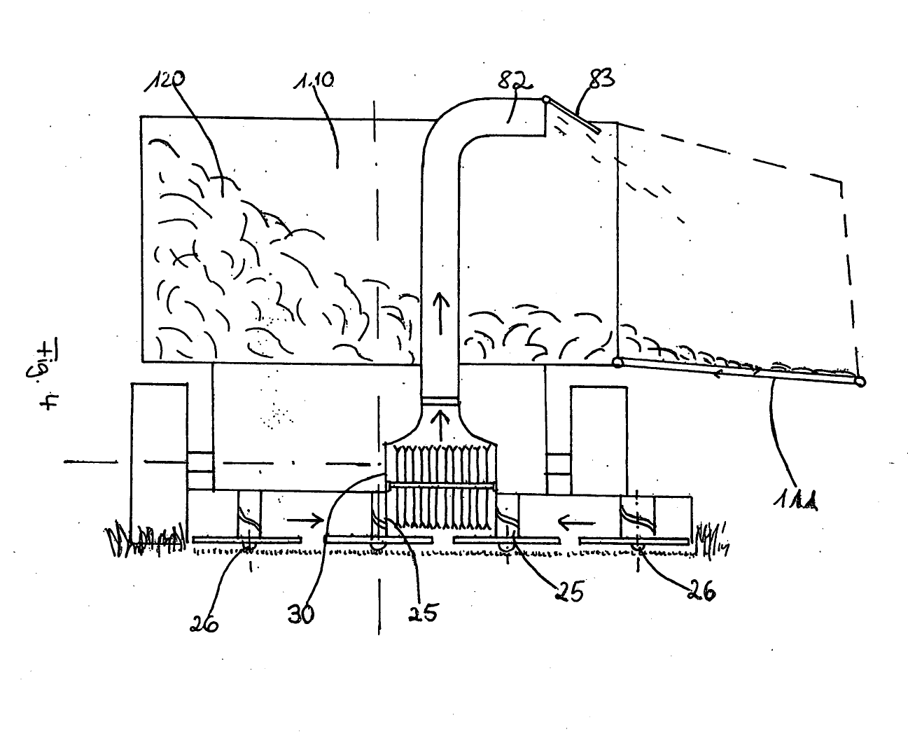

FIG. 4—a front view of a mowing unit with the chopping device and the discharge device; and

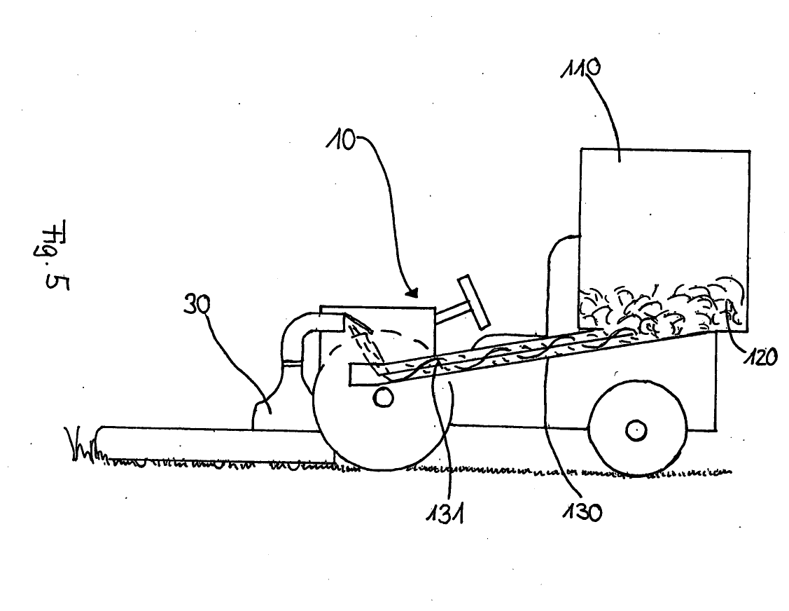

FIG. 5—a side view of a mowing unit with the chopping device and the discharge device.

FIG. 1 shows a schematic top view of a particularly preferred embodiment of the invention. This is a mowing device for taking care of lawns and fields in the form of a self-propelled mowing unit 10 that preferably has a seat. The unit has at least one mowing assembly that is coupled to the tractor 10. The device according to the invention, however, can also be attached as an add-on component to conventional mowers.

In the especially preferred embodiment of the invention being presented, the unit comprises two mowing assemblies that are linked to the front of the tractor 10 in a V-formation. In order to configure the mowing unit to be employed for taking care of lawns and fields in a manner that is as compact and maneuverable as possible, it has proven to be advantageous for the tractor not to exceed the height of two meters, even with any add-on components such as collecting containers or discharge devices. The width can be selected at will and preferably lies in the order of magnitude of 1.50 m to 2.20 m. Naturally, depending on the area of application, larger or smaller dimensions are likewise conceivable.

The V-formation of the mowing assemblies depicted in FIG. 1 entails several advantages. For instance, the mowing assemblies can then be installed as close as possible to the tractor, which translates into a high level of compactness and maneuverability of the mowing unit. Moreover, it is then easy to mow around obstacles such as trees by driving directly towards the obstacle so that the mowing assemblies can mow very close in front and to the sides of the obstacle.

Furthermore, the arrangement of the mowing assemblies in a V-formation means that it is not necessary for the individual mowing assemblies to overlap in order to avoid leaving unmowed grass strips between the aggregates. Instead, through the staggered arrangement of the mowing aggregates in the forward direction, the mowing aggregate that is behind then cuts the grass that was not mowed by the preceding mowing aggregate. This arrangement has the advantage that the positions of the cutting means do not have to be coordinated with each other as is necessary with overlapping mowing aggregates in order to prevent the cutting means from colliding with each other. Moreover, overlapping mowing aggregates have to be driven uniformly, which is typically achieved with chain and timing belt drives or other types of drives. Any slippage of the timing belt, however, causes a cutting means to be in the wrong position where it can then collide with another cutting means and thus be damaged. In contrast, with a non-overlapping arrangement of the mowing aggregates, the latter can be connected and driven using simple V-belts, with which slippage does not cause any damage.

Advantageously, the mowing assemblies are configured so as to pivot around at least one horizontal axle. Thus, the mowing assemblies, can be lifted, for example, when the mowing unit is being driven normally and lowered once the mowing operation is started. In this manner, they can also adapt to uneven areas in the terrain. Furthermore, the mowing assemblies can be pivoted around an axle that is essentially perpendicular to the surface of the ground, so that the width of the mowing area can be varied. Hence, a variable cutting width can be attained.

It has also turned out to be practical to configure the individual mowing aggregates so that their height can vary independently of each other. This provides better contact with the ground when the mower drives over irregular sections of the terrain.

The mowing assemblies employed each comprise at least one mowing aggregate 20 made up of one or more cutting means. In the embodiment shown, the mowing unit has one mowing assembly with three aggregates and one mowing assembly with two aggregates, whereby the aggregates are positioned next to each other and the mowing aggregate in the middle belongs to both mowing assemblies. The cutting means are advantageously rotating blades. Here, the cutting means rotate around an axle 21 perpendicular to the surface of the ground being mowed. Typical diameters for a mowing aggregate range from 30 cm to 80 cm, so that the above-mentioned V-formation of the mowing assemblies with four aggregates results in a mowing width ranging from 90 cm to 250 cm.

In a particularly preferred embodiment of the invention, the chopping device 30 according to the invention used for comminuting and drying the clippings is located above the mowing aggregate 20 of a mowing assembly, so that the clippings enter the chopping device 30 from below, where they are then processed. The device, however, can also be positioned as desired relative to the mowing assemblies insofar as this is appropriate for the envisaged application purpose. For instance, it can also be located next to the mowing assemblies. In the embodiment shown, the chopping device 30 extends above the center aggregate on the vehicle axle and the first mowing aggregate of a mowing assembly.

The chopping device 30 is configured in such a way that its chopping means 40 rotate around an axle 50 that lies essentially perpendicular to the rotating axle 21 of the cutting means of the mowing aggregates 20. In this context, the term “essentially” comprises angles ranging from 60° to 90° between the axle of the cutting means and the axle of the chopping means. The chopping means 40 are advantageously suitably shaped chopper blades or chopper flails that ensure a thorough comminution of the clippings.

The axle 50 and the chopping means 40 that rotate around this axle are located in a housing 60 that, for purposes of sucking in the clippings, is open towards one side and has a discharge opening on the opposite side. If the chopping device 30 is arranged above the mowing aggregates 20, the housing 60 is consequently open towards the bottom. In order to prevent clipping residues from accumulating in the area of the discharge opening, it has proven to be advantageous to shape the discharge opening like a funnel. This generates an air current in the housing and in the discharge opening that then ejects the clippings through the opening.

In an especially preferred embodiment of the invention, a cover 70 extends over each of the mowing assemblies. In order for the clippings not to be squashed between the cutting means and the cover, this cover is positioned at a certain minimum distance from the rotating cutting means of the aggregates 20. In the area of the chopping device 30, the appertaining cover has a cutout in order to allow the clippings to enter the chopping device. The housing 60 of the chopping device 30 and the cover 70 can be connected to each other and can be made, for example, in one piece.

The grass to be mowed is cut off at an adjustable height by the rotating cutting means 22 and the clippings are transported to the tractor of the mowing unit by means of the rotation of the cutting means underneath the cover 70. For this purpose, the cutting means 22 rotate inwards in the direction of the longitudinal axis of the mowing unit. Once the clippings have reached the area underneath the chopping device 30, they are picked up by the rotation of the chopping means 40 and sucked into the chopping device, where they are comminuted and discharged via the discharge opening. At the same time, this procedure partially dries them.

It has been found to be practical if the height adjustment of the mowing assemblies can be set from the driver's seat. In this manner, the operator of the mowing unit can quickly respond to changes in the terrain being mowed without the need for tedious height adjustments of the mowing aggregates.

In order to attain a constant height, typical mowing aggregates have several rollers distributed on their rim which then keep the cutting means at the set height. This has the drawback that, for instance, when the mowing unit leaves a grassy area and drives over a curb, one or more rollers already tip over the edge of the curb while the other rollers are still on the grassy area, with the result that the cutting means of the mowing aggregate in question can strike the edge of the curb and can be damaged. Therefore, the invention provides for the height setting of a mowing aggregate to be configured with only one height guide that is preferably located in the middle, underneath the aggregate. This height guide can be connected, for example, to a chute surrounding the rotating axle 21 of the mowing aggregate 20 in such a way that the height can be set from the driver's seat. The guide itself can be configured as a castor, roller, rail, ball or other element that can easily move over the ground without readily wearing down or becoming blocked. Such height guides 26 are shown in FIG. 4.

The axles 21 of the aggregate can be shaped appropriately to assist the transport movement of the clippings from the mowing aggregates towards the axle of the vehicle. Thus, they can be designed, for instance, as drums with wings or as rotating screws by means of which the clippings are made to rotate, thus being conveyed from one aggregate to the next. Such rotation elements 25 are depicted in FIG. 4.

The funnel-like discharge opening of the chopping device 30 is connected to a discharge device 80 that is advantageously configured in such a fashion that the clippings can be discharged in different ways. Advantageously, the funnel-like discharge opening first makes the transition into a first chute which is followed by a slewing gear 81. Connected to this slewing gear is a second chute 82 that can be turned by means of the slewing gear. Both the first and the second chutes can have a curved shape. This is particularly advantageous for purposes of keeping the height of the entire mowing unit as low as possible. If the discharge chute 82 is too high, it is not possible, for example, to drive under low-hanging trees and shrubs while taking care of lawns and fields. For certain applications, it can be advantageous if it is possible to adjust the height of the discharge chute.

The end of the chute 82 can be fitted with at least one adjustable flap 83 whose position can regulate the direction and range of the discharge of the clippings. It is likewise advantageous if this regulation can be carried out from the driver's seat.

The clippings can be discharged as a function of the particular requirements, whereby the discharge can be effectuated in different ways.

The entire mowing unit is advantageously driven by means of at least one engine 90 that is connected to a main drive shaft 100. This drive shaft drives at least the tractor 10, the mowing aggregate 20 and the chopping device 30. If the discharge device is additionally equipped with a blower, the latter can also be driven by the engine. Gears can be installed between the engine and the various aggregates. The individual components can be driven, for example, by means of belts or else hydraulically.

FIG. 2 shows a schematic side view of the chopping device 30 according to the invention. In this particularly preferred embodiment of the invention, the chopping device 30 extends above two mowing aggregates. Above the mowing aggregates, there is at least one cover 70, whereby the cover 70 is preferably partially formed with an outer rim 71 that serves to keep the clippings under the cover. For this purpose, the outer rim extends along the side of the tractor, while the cover is open in the forward direction. In the area of the chopping device 30, the cover has a cutout so that the clippings can be sucked into the device. The housing 60 of the chopping device and the cover 70 can be connected to each other and can be designed, for instance, as a single piece.

Above the part of the other mowing aggregate, which does not have a chopping device and which is not shown in this figure, there is likewise a cover under which the clippings are carried towards the tractor. Once they reach the area underneath the chopping device, they are likewise sucked in. In this especially preferred embodiment of the invention, the chopping device 30 is located above the middle mowing aggregate and above the next aggregate of a mowing assembly, so that it is positioned on one side of the longitudinal axis of the mowing unit 10. In other embodiments of the invention, however, it is also possible for the chopping device to be positioned precisely on the longitudinal axis of the mowing unit, so that the clippings are carried to the middle of the mowing unit, where they are sucked in by the chopping device.

In order to allow a selection among various settings of the chopping device, it has proven advantageous to configure the chopping device with an adjusting mechanism so that the operator can choose between at least two degrees of comminution. For instance, he can choose between fine and coarse. The setting of the degree of comminution is preferably done from the driver's seat.

In conventional mowing assemblies, there is typically a cover about 10 cm above the cutting means, and the clippings are kept underneath this cover. As a result, the clippings are squashed underneath the cover, which creates a damp and hard-to-handle mass. In order to avoid this drawback, the cover 70 of the device according to the invention is positioned at a certain minimum distance from the rotating cutting means 22, and this ensures that the clippings are not squashed, but rather, merely cut off and moved in the direction of the longitudinal axis of the mowing unit, where they are sucked into the area of the chopping device 30. Depending on the area of application of the mowing unit, the distance between the cutting means 22 and the cover 70 ranges from 10 cm to 55 cm.

The drive of the mowing aggregates 20 and the connection of the mowing assembly to the tractor are not shown in FIG. 2. This part of the mowing unit 10 can be configured as desired as long as it fulfills the functions of the mowing unit. The type of configuration, however, is not relevant for the chopping device 30 according to the invention, since it can be used for all kinds of variants of mowing units that are fitted with mowing assemblies. Since the mowing aggregates do not overlap, for the reasons elaborated upon above, a simple V-belt drive, for example, can be employed.

FIG. 3 shows an especially preferred embodiment of a mowing aggregate 20 that comprises several cutting means 22. Normally, blades are used as the cutting means. If a blade becomes damaged, which can happen, for instance, when it strikes a stone, the blade is then replaced. If large elongated blades are employed, this means that the entire blade has to be replaced, even though perhaps only a small section of the cutting edge has been damaged. Therefore, in order to keep the loss of material as low as possible in case of such a replacement, it has proven to be advantageous to use smaller blades which are affixed to a carrier element 24. In a particularly preferred embodiment of the invention, this carrier element is star-shaped with three legs. However, other shapes are likewise conceivable. At the end of each leg, there is blade 22 affixed in a detachable manner. The attachment can be effectuated, for example, by means of a secured pin joint 23. Now, when a blade gets damaged, it can be replaced without a large loss of material.

The cutter blades of the mowing aggregates can have a winged shape, so that there are wings on their ends facing outwards and away from the surface of the ground being mowed. As a result of this shape, an additional suction effect away from the surface of the ground is generated by the rotation of the cutting means. Among other things, this has the advantage that grass that has been matted down by the tires of the mowing unit is lifted up again by the suction effect of the cutting means so that it can then be cut.

FIG. 4 shows a schematic front view of an especially preferred embodiment of a mowing unit 10 with a chopping device 30. The clippings 120 comminuted by the chopping device reach the discharge device 80 via the funnel-like discharge opening. As an advantageous side effect, when the clippings pass through the discharge device, they are not only comminuted but also partially dried in the air current. Ideally, this drying operation can be assisted by a blower.

In order for the discharge to be adapted to the particular use of the mowing unit, the clippings can be discharged in different ways. Several variants exist for this purpose. In one variant, the clippings 120 are discharged in swaths next to or in front of the mowing unit. Discharging in front of the mowing unit, for instance, entails the advantage that the clippings are once again picked up by the chopping device 30 and are then comminuted even further. If the clippings are discharged in strips next to the mowing unit, they can be left lying there on the ground for some time in order to dry, after which they are once again picked up by the chopping device of the mowing unit. With this technique, a volume reduction of up to 50% can be attained.

In another variant, the discharge takes place directly into a collecting container 110. This collecting container can be placed on an additional vehicle that rides next to the mowing unit 10 or it can be on the tractor itself. In order to keep the height of the mowing unit as low as possible, it can be advantageous to discharge the clippings not upwards into a collecting container but rather into a conveying device that is located on the vehicle at a lower point than the collecting container and that then conveys the clippings further. FIG. 5 shows a side view of such a conveying device 130 with the appertaining collecting container 110 arranged on the mowing unit. The clippings 120 comminuted by the chopping device 30 are systematically conveyed through the discharge device 80 equipped with the discharge chute 82 into the conveying device 130, which then transports the clippings into the collecting container 110. The conveying device can be configured in such a way, for instance, that there is a conveying screw 131 that moves the clippings. However, other conveying techniques can also be employed. In order to allow the air that blows together with the clippings into the conveying device to escape, the top of the conveying device is designed, for example, as a sieve that is open towards the top.

The conveying device 130 can transfer the clippings to the collecting container 110 in different ways. On the one hand, the possibility exists to let the clippings drop from above into the collecting container while, on the other hand, the conveying device can end at the bottom of the collecting container, so that the clippings are deposited from below into the collecting container. This presupposes a conveying device that can generate sufficient power to force the clippings into the collecting container without pushing the clippings out of the open conveying device and without clogging. This variant entails the advantage that the clippings can be compressed by the pressure generated from above, as a result of which the volume can be further reduced.

By the same token, the collecting container 110 can be configured in different ways. For example, at least one side of the collecting container can be designed so that it can flip open, thus allowing the collecting container to be emptied in this manner. In order to facilitate the emptying procedure, the side wall and/or the bottom can have belts and/or chains as an endless floor 111 over which the clippings are hauled away.

In another variant, the clippings are blown in a flat pattern over the ground by appropriately positioning the discharge chute 82. This can be done with the discharge chute itself or with an additional discharge means that is positioned close to the ground and into which the clippings are deposited by the discharge chute 82. This is advantageous if, for example, the objective is not to haul the clippings away but rather to dispose of them under bushes. In this variant of the mode of operation, if no clippings are picked up, but instead only air is sucked into the chopping device, then the discharge chute 82 and/or the additional discharge means that is positioned close to the ground can also be employed as a blower in order to blow away leaves and the like. Accordingly, the discharge chute can be fitted with various additional accessories for different purposes, so that the mowing unit according to the invention for use in taking care of lawns and fields constitutes an extremely flexible device.

The mowing unit with its chopping device entails further advantages in comparison to conventional mowing units. For instance, the clippings are not squashed under the cover 70, so that even if the weather is bad, wet grass can be mowed without the soggy grass making the mowing difficult or even impossible. The clippings are comminuted, so that smaller volumes have to be hauled away and the chopping device and the discharge device also partially dry the clippings. Moreover, the greater distance between the mowing aggregates 20 and the cover 70 allows longer grass to be mowed, which is often not possible with conventional mowing units.

The mowing unit also entails a very high degree of flexibility since many different modes of operation can be controlled from the driver's seat. The operator can, for instance, decide how high the grass will be cut, whether the clippings will be picked up or left lying and where the clippings will be discharged. The mowing unit can also be employed to clear, pick up and comminute leaves, whereby the discharge chute 82 is also suitable as a blower. All variants of the mode of operation are realized in an extremely compact and maneuverable configuration of the mowing unit.

### List of Reference Numerals

10 tractor/mowing unit

20 mowing aggregate

21 rotating axle of the mowing aggregate

22 cutting means of the mowing aggregate

23 attachment of the cutting means

24 carrier element of the mowing aggregate

25 rotation element

26 height guide

30 chopping device

40 chopping means

50 rotating axle of the chopping device

60 housing

70 cover

71 outer rim of the cover

80 discharge device

81 slewing gear

82 discharge chute

83 flap

90 engine

100 main drive shaft

110 collecting container

111 side wall with endless floor

120 clippings

130 conveying device

131 conveying screw

1. A device for picking up and comminuting clippings in a mowing unit used for taking care of lawns and fields, wherein the mowing unit comprises at least one mowing assembly of comprising at least one mowing aggregate having cutters and a rotating axle, the device further comprising a chopper for sucking in and comminuting clippings produced by the mowing aggregate, and for feeding the comminuted clippings to a discharge device, the chopper having a rotating axle disposed at an angle relative to the rotating axle of the mowing aggregate.

2. The device of claim 1, wherein the angle between the rotating axle of the chopping device chopper and the rotating axle of the mowing aggregate ranges from 60° to 90°.

3. The device of claim 1 wherein the chopper is arranged above at least one mowing aggregate.

4. The device of claim 1, wherein the mowing unit encompasses at least one motor-driven tractor and two mowing assemblies, wherein the mowing assemblies are pivotally connected to the tractor by at least one horizontal axle.

5. The device of claim 4, wherein a plurality of mowing assemblies are arranged in a V-formation on the front of a tractor.

6. The device claim 4 5, wherein the mowing assemblies arranged in a V-formation can pivot around an axle that is perpendicular to the ground surface to be mowed.

7. The device of claim 5 wherein a mowing assembly of comprises at least two mowing aggregates that rotate inwardly in the direction of the longitudinal axis of the tractor and the chopper extends over at least the two mowing aggregates that are closest to the tractor.

8. The device claim 1, comprising a plurality of chopping elements which rotate aroung the axle of the chopper, said axle extending inside a housing that is open toward one side of the mowing aggregate so that it can pick up the clippings while, on the opposite side of the mowing aggregate, there is a discharge opening that is connected to a discharge device.

9. The device of claim 8, wherein the discharge opening is funnel-shaped.

10. The device of claim 8, wherein different discharge directions of the discharge can be selected.

11. The device of claim 10, wherein the discharge comprises a first chute that is rigidly attached to the chopper, whereby the first chute is followed by a slewing gear that is connected to a second chute, whereby the second chute can be turned by means of the slewing gear.

12. The device of claim 11, comprising at least one adjustable flap at an end of the second chute for purposes of regulating the direction and range of the discharge.

13. The device of claim 8 wherein the height of the discharge can be adjusted.

14. The device claim 1, comprising at least one cover above each of the mowing assemblies, said cover shaving an outer rim on a side of the tractor and which is open in the forward direction.

15. The device of claim 14, wherein the cover is positioned at a certain distance from cutters of the mowing aggregates at which distance the clippings are only slightly squashed under the cover.

16. The device of claim 15, wherein the distance between the cover and the cutters ranges from 10 cm to 55 cm.

17. The device of claim 14, wherein the cover has a cutout in the area of the chopping device.

18. The device of claim 14, wherein the cover and the housing of the chopper are a single piece.

19. The device of claim 1, wherein the tractor sis driven by an engine and by a main drive shaft.

20. The device of claim 19, wherein the mowing aggregate is driven by the drive shaft.

21. The device claim 19 wherein the chopper is driven by the drive shaft.

22. The device of claim 1, wherein the mowing assemblies and the choppers are driven by V-belts.

23. The device of claim 1, wherein different degrees of comminution can be selected for the chopper.

24. The device of claim 1, wherein the mowing aggregates have several blades detachably affixed to the ends of each of a plurality of legs of a star-shaped carrier element, wherein the carrier element rotates around the rotating axle.

25. The device of claim 1, wherein in the area of the rotating axle, the mowing aggregates have additional rotation elements with which the clippings are made to rotate and transported to the middle of the vehicle.

26. The device of claim 25, wherein the rotation elements are formed by a drum with wings.

27. The device of claim 25, wherein the rotation elements are formed by a drum with a rotating screw.

28. The device of claim 1, wherein the mowing unit has a conveyer into which the clippings are discharged, whereby the conveyor transports the clippings to a collecting container.

29. The device of claim 28, wherein the conveyor comprises a chute in which the clippings are transported by means of a conveying screw.

30. The device of claim 29, wherein the chute of the conveyor is a sieve that is open towards its top.

31. The device of claim 1, wherein the mowing unit has a collecting container of which at least one side wall can flip open towards the outside.

32. The device of claim 31, wherein at least one of the side wall and the bottom of the collecting container is as an endless floor so that the container can be emptied.

33. The device of claim 1, wherein the height of the mowing aggregates can be varied independently of each other.

34. The device of claim 1, wherein the height of each of the mowing aggregates is set by means of a height guide located in the middle, underneath the aggregate.

35. The device of claim 34, wherein the height guide is a tube that encircles rotating axle of the mowing aggregate and has at least one guide element.

36. A method for mowing and picking up clippings by means of a mowing unit, that has a chopper, comprising the steps of:
cutting of the plants by a cutter of at least one mowing aggregate (20),
sucking in, comminuting, and releasing the clippings by a chopper in the vicinity of the mowing unit; and
picking up and conveying the clippings, after drying in the vicinity, by the chopping device to a collector.

37. The device of claim 34, wherein the guide element is selected from the group consisting of casters, rollers, rails, and balls.
